(19) United States
(12) Patent Application Publication
(10) Pub. No.: US 2024/0429595 A1
(43) Pub. Date: Dec. 26, 2024

(54) ANTENNA STRUCTURE AND ELECTRONIC DEVICE COMPRISING SAME

(71) Applicant: Samsung Electronics Co., Ltd., Suwon-si, Gyeonggi-do (KR)

(72) Inventors: Kyuho LEE, Suwon-si (KR); Youngseok BANG, Suwon-si (KR); Donguk CHOI, Suwon-si (KR); Youngjin OH, Suwon-si (KR); Juntaek OH, Suwon-si (KR); Yongsang YUN, Suwon-si (KR)

(21) Appl. No.: 18/824,435

(22) Filed: Sep. 4, 2024

Related U.S. Application Data
(63) Continuation of application No. PCT/KR2023/001616, filed on Feb. 3, 2023.

(30) Foreign Application Priority Data
Mar. 30, 2022 (KR) 10-2022-0039336
May 11, 2022 (KR) 10-2022-0058023

(51) Int. Cl. H01Q 1/27; H01Q 1/22; H04R 1/10

(52) U.S. Cl. CPC H01Q 1/273; H01Q 1/2291; H04R 1/1016; H04R 1/1041

(57) ABSTRACT

An electronic device is provided. The electronic device includes a housing including a first surface facing a first direction and a second surface facing a second direction different from the first direction, an sound output module disposed within the housing, a circuit board disposed within the housing, a first antenna pattern disposed within the housing and electrically connected to the circuit board, and a second antenna pattern disposed on the first surface of the housing and configured to be electromagnetically coupled to the first antenna pattern, wherein the first antenna pattern includes a first portion disposed adjacent to the second surface of the housing and a second portion extending from the first portion, and wherein the first portion of the first antenna pattern faces at least a portion of the second antenna pattern with the housing interposed therebetween.

### CROSS-REFERENCE TO RELATED APPLICATION(S)

This application is a continuation application, claiming priority under § 365 (c), of an International application No. PCT/KR2023/001616, filed on Feb. 3, 2023, which is based on and claims the benefit of a Korean patent application number 10-2022-0039336, filed on Mar. 30, 2022, in the Korean Intellectual Property Office, and of a Korean patent application number 10-2022-0058023, filed on May 11, 2022, in the Korean Intellectual Property Office, the disclosure of each of which is incorporated by reference herein in its entirety.

### BACKGROUND

### 1. Field

The disclosure relates to an electronic device. More particularly, the disclosure relates to an antenna structure and an external electronic device accommodating the same.

### 2. Description of Related Art

An electronic device may refer to a device that executes a specific function according to a loaded program, such as a home appliance, an electronic notebook, a portable multimedia player, a mobile communication terminal, a tablet personal-computer (PC), a video/audio device, a desktop/laptop computer, or a vehicle navigation device. For example, these electronic devices may output stored information as sound or an image. As the integration level of electronic devices increases and high-speed, large-capacity wireless communication becomes more common, a single electronic device such as a mobile communication terminal may recently be equipped with various functions. For example, an entertainment function such as games, a multimedia function such as music/video playback, a communication and security function for mobile banking, and a function such as schedule management or an electronic wallet in addition to a communication function are integrated into a single electronic device. Along with the development of electronic and communication technologies, these electronic devices are becoming smaller and lighter such that they may be used with comfort even when worn on the body.

The above information is presented as background information only to assist with an understanding of the disclosure. No determination has been made, and no assertion is made, as to whether any of the above might be applicable as prior art with regard to the disclosure.

### SUMMARY

A wearable electronic device (e.g., a wireless earphone) may include an antenna for communication with an external electronic device. For example, the antenna of the wearable electronic device may be disposed inside a housing (or a case) that forms the exterior of the wearable electronic device.

As wearable electronic devices become miniaturized, various electrical components may be mounted in the internal space of a miniaturized wearable electronic device. The wearable electronic device may have a high integration level of components and an insufficient distance between a circuit board (e.g., a printed circuit board (PCB)) and an antenna inside it. Moreover, a sufficient distance between a user's body (e.g., ear) and the antenna may not be secured due to the miniaturization of the wearable electronic device. As such, there is a risk that antenna performance may not be sufficiently secured because the antenna of the wearable electronic device is not sufficiently separated from the circuit board or the user's body.

Additionally, as the integration level of wearable electronic devices increases, sufficient freedom in antenna design may not be secured due to a large number of electrical components mounted inside the wearable electronic device.

Aspects of the disclosure are to address at least the above-mentioned problems and/or disadvantages and to provide at least the advantages described below. Accordingly, an aspect of the disclosure is to provide an antenna structure with improved antenna performance and an electronic device including the same.

Additional aspects will be set forth in part in the e description which follows and, in part, will be apparent from the description, or may be learned by practice of the presented embodiments.

In accordance with an aspect of the disclosure, an electronic device is provided. The electronic device includes a housing including a first surface facing a first direction and a second surface facing a second direction different from the first direction, a sound output module disposed within the housing, a circuit board disposed within the housing, a first antenna pattern disposed within the housing and electrically connected to the circuit board, and a second antenna pattern disposed on the first surface of the housing and configured to be electromagnetically coupled to the first antenna pattern, wherein the first antenna pattern includes a first portion disposed adjacent to the second surface of the housing and a second portion extending from the first portion, and wherein the first portion of the first antenna pattern faces at least a portion of the second antenna pattern with the housing interposed therebetween.

In accordance with another aspect of the disclosure, an electronic device is provided. The electronic device includes a housing including a first surface facing a first direction and a second surface facing a second direction different from the first direction, a sound output module disposed within the housing, a circuit board disposed within the housing, a first antenna structure disposed within the housing and electrically connected to the circuit board, and a second antenna pattern disposed on the first surface of the housing and configured to be electromagnetically coupled to the first antenna structure. The first antenna structure is disposed adjacent to the second surface of the housing and at least a portion of the first antenna structure faces at least a portion of the second antenna structure with the housing interposed therebetween. The second antenna structure is a laser direct structuring (LDS) antenna formed on the first surface of the housing.

In accordance with another aspect of the disclosure, an electronic device is provided. The electronic device includes a housing including a first housing including a first surface facing a first direction and a second surface facing a second direction different from the first direction, and a second housing coupled to the first housing, a sound output module disposed in the second housing, a circuit board disposed within the housing, a first antenna pattern disposed adjacent to the second surface of the first housing and electrically connected to the circuit board, and a second antenna pattern disposed adjacent to the first surface of the first housing and configured to be electromagnetically coupled to the first antenna pattern. At least a portion of the first antenna pattern faces at least a portion of the second antenna pattern with the first housing interposed therebetween.

According to various embodiments of the disclosure, the design freedom of an antenna structure may be improved by disposing at least a portion of the antenna structure on a first surface (or outer surface) of a housing in an electronic device.

According to various embodiments of the disclosure, an antenna outside the housing and an antenna inside the housing may be electromagnetically coupled to each other without a separate mechanical structure or part to connect the antennas.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating an electronic device in a network environment according to an embodiment of the disclosure;

FIG. 2 is a block diagram illustrating an audio module according to an embodiment of the disclosure;

FIG. 3 is a side view illustrating an electronic device according to an embodiment of the disclosure;

FIG. 4 is a top view illustrating an electronic device according to an embodiment of the disclosure;

FIG. 5 is a diagram illustrating an antenna structure and a housing according to an embodiment of the disclosure;

FIG. 6 is a cross-sectional view illustrating an electronic device according to an embodiment of the disclosure;

FIG. 7 is a top view illustrating a first housing according to an embodiment of the disclosure;

FIG. 8 is a bottom view illustrating a first housing according to an embodiment of the disclosure;

FIG. 9 is a perspective view illustrating a first housing according to an embodiment of the disclosure;

FIG. 10 is a diagram illustrating an antenna structure and a housing according to an embodiment of the disclosure; and

FIG. 11 is a cross-sectional perspective view illustrating an electronic device according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

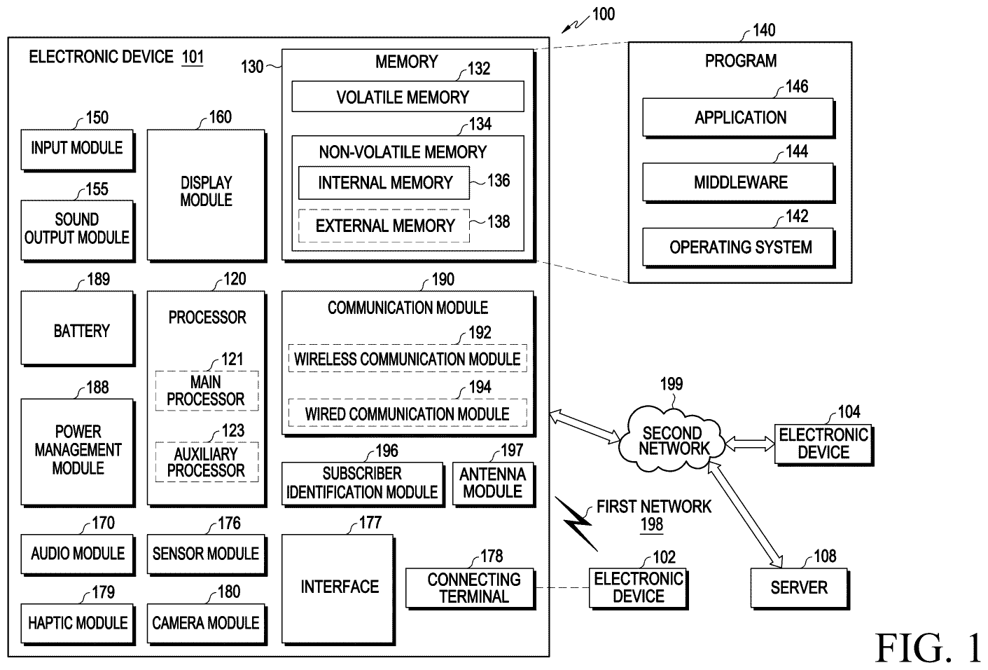

FIG. 1 is a block diagram illustrating an electronic device 101 in a network environment 100 according to an embodiment of the disclosure.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment of the disclosure, the electronic device 101 may communicate with the electronic device 104 via the server 108. According to an embodiment of the disclosure, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment of the disclosure, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment of the disclosure, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment of the disclosure, the auxiliary processor 123 (e.g., an image signal processor or a communication processor) may be implemented as part of another component (e.g., the camera module 180 or the communication module 190) functionally related to the auxiliary processor 123. According to an embodiment of the disclosure, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment of the disclosure, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment of the disclosure, the display module 160 may include a touch sensor adapted to detect a touch, or a pressure sensor adapted to measure the intensity of force incurred by the touch.

The audio module 170 may convert a sound into an electrical signal and vice versa. According to an embodiment of the disclosure, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment of the disclosure, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment of the disclosure, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment of the disclosure, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment of the disclosure, the haptic module 179 may include, for example, a motor, a piezoelectric element, or an electric stimulator.

The camera module 180 may capture a still image or moving images. According to an embodiment of the disclosure, the camera module 180 may include one or more lenses, image sensors, image signal processors, or flashes.

The power management module 188 may manage power supplied to the electronic device 101. According to an embodiment of the disclosure, the power management module 188 may be implemented as at least part of, for example, a power management integrated circuit (PMIC).

The battery 189 may supply power to at least one component of the electronic device 101. According to an embodiment of the disclosure, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment of the disclosure, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth-generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth-generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment of the disclosure, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment of the disclosure, the antenna module 197 may include an antenna including a radiating element composed of a conductive material or a conductive pattern formed in or on a substrate (e.g., a printed circuit board (PCB)). According to an embodiment of the disclosure, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment of the disclosure, another component (e.g., a radio frequency integrated circuit (RFIC)) other than the radiating element may be additionally formed as part of the antenna module 197.

According to various embodiments of the disclosure, the antenna module 197 may form an mmWave antenna module. According to an embodiment of the disclosure, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment of the disclosure, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment of the disclosure, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment of the disclosure, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. As used herein, each of such phrases as “A or B”, “at least one of A and B”, “at least one of A or B”, “A, B, or C”, “at least one of A, B, and C”, and “at least one of A, B, or C”, may include any one of, or all possible combinations of the items enumerated together in a corresponding one of the phrases. As used herein, such terms as “1^{st}” and “2^{nd}”, or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with”, “coupled to”, “connected with”, or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, logic, logic block, part, or circuitry. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment of the disclosure, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments of the disclosure, each component (e.g., a module or a program) of the above-described components may include a single entity or multiple entities, and some of the multiple entities may be separately disposed in different components. According to various embodiments of the disclosure, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments of the disclosure, operations performed by the module, the program, or another component may be carried out sequentially, in parallel, repeatedly, or heuristically, or one or more of the operations may be executed in a different order or omitted, or one or more other operations may be added.

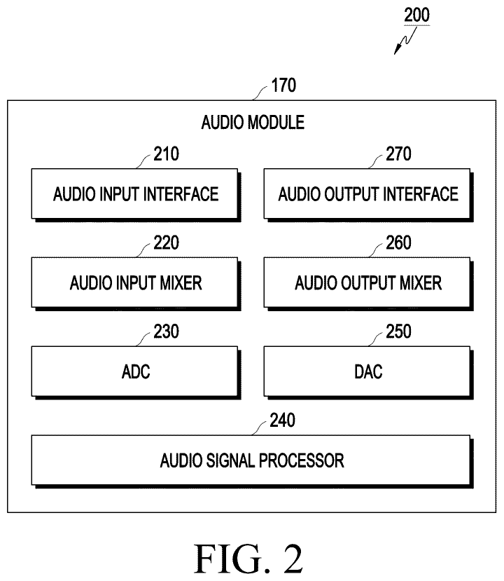

FIG. 2 is a block diagram 200 illustrating the audio module 170 (e.g., the audio module 170 in FIG. 1) according to an embodiment of the disclosure.

Referring to FIG. 2, the audio module 170 may include, for example, an audio input interface 210, an audio input mixer 220, an analog-to-digital converter (ADC) 230, an audio signal processor 240, a digital-to-analog converter (DAC) 250, an audio output mixer 260, or an audio output interface 270.

The audio input interface 210 may receive an audio signal corresponding to a sound obtained from the outside of the electronic device 101 via a microphone (e.g., a dynamic microphone, a condenser microphone, or a piezo microphone) that is configured as part of the input module 150 (e.g., the input module 150 in FIG. 1) or separately from the electronic device 101 (e.g., the electronic device 101 in FIG. 1). For example, if an audio signal is obtained from the external electronic device 102 (e.g., a headset or a microphone), the audio input interface 210 may be connected with the external electronic device 102 directly via the connecting terminal 178 (e.g., the connecting terminal 178 in FIG. 1), or wirelessly (e.g., Bluetooth™ communication) via the wireless communication module 192 (e.g., the wireless communication module 192 in FIG. 1) to receive the audio signal. According to an embodiment of the disclosure, the audio input interface 210 may receive a control signal (e.g., a volume adjustment signal received via an input button) related to the audio signal obtained from the external electronic device 102. The audio input interface 210 may include a plurality of audio input channels and may receive a different audio signal via a corresponding one of the plurality of audio input channels, respectively. According to an embodiment of the disclosure, additionally or alternatively, the audio input interface 210 may receive an audio signal from another component (e.g., the processor 120 or the memory 130 in FIG. 1) of the electronic device 101.

The audio input mixer 220 may synthesize a plurality of inputted audio signals into at least one audio signal. For example, according to an embodiment, the audio input mixer 220 may synthesize a plurality of analog audio signals inputted via the audio input interface 210 into at least one analog audio signal.

The ADC 230 may convert an analog audio signal into a digital audio signal. For example, according to an embodiment, the ADC 230 may convert an analog audio signal received via the audio input interface 210 or, additionally or alternatively, an analog audio signal synthesized via the audio input mixer 220 into a digital audio signal.

The audio signal processor 240 may perform various processing on a digital audio signal received via the ADC 230 or a digital audio signal received from another component of the electronic device 101. For example, according to an embodiment, the audio signal processor 240 may perform changing a sampling rate, applying one or more filters, interpolation processing, amplifying or attenuating a whole or partial frequency bandwidth, noise processing (e.g., attenuating noise or echoes), changing channels (e.g., switching between mono and stereo), mixing, or extracting a specified signal for one or more digital audio signals. According to an embodiment of the disclosure, one or more functions of the audio signal processor 240 may be implemented in the form of an equalizer.

The DAC 250 may convert a digital audio signal into an analog audio signal. For example, according to an embodiment, the DAC 250 may convert a digital audio signal processed by the audio signal processor 240 or a digital audio signal obtained from another component (e.g., the processor 120 or the memory 130) of the electronic device 101 into an analog audio signal.

The audio output mixer 260 may synthesize a plurality of audio signals, which are to be outputted, into at least one audio signal. For example, according to an embodiment, the audio output mixer 260 may synthesize an analog audio signal converted by the DAC 250 and another analog audio signal (e.g., an analog audio signal received via the audio input interface 210) into at least one analog audio signal.

The audio output interface 270 may output an analog audio signal converted by the DAC 250 or, additionally or alternatively, an analog audio signal synthesized by the audio output mixer 260 to the outside of the electronic device 101 via the sound output module 155 (e.g., the sound output module 155 in FIG. 1). The sound output module 155 may include, for example, a speaker, such as a dynamic driver or a balanced armature driver, or a receiver. According to an embodiment of the disclosure, the sound output module 155 may include a plurality of speakers. In such a case, the audio output interface 270 may output audio signals having a plurality of different channels (e.g., stereo channels or 5.1 channels) via at least some of the plurality of speakers. According to an embodiment of the disclosure, the audio output interface 270 may be connected with the external electronic device 102 (e.g., an external speaker or a headset) directly via the connecting terminal 178 or wirelessly via the wireless communication module 192 to output an audio signal.

According to an embodiment of the disclosure, the audio module 170 may generate, without separately including the audio input mixer 220 or the audio output mixer 260, at least one digital audio signal by synthesizing a plurality of digital audio signals using at least one function of the audio signal processor 240.

According to an embodiment of the disclosure, the audio module 170 may include an audio amplifier (not shown) (e.g., a speaker amplifying circuit) that is capable of amplifying an analog audio signal inputted via the audio input interface 210 or an audio signal that is to be outputted via the audio output interface 270. According to an embodiment of the disclosure, the audio amplifier may be configured as a module separate from the audio module 170.

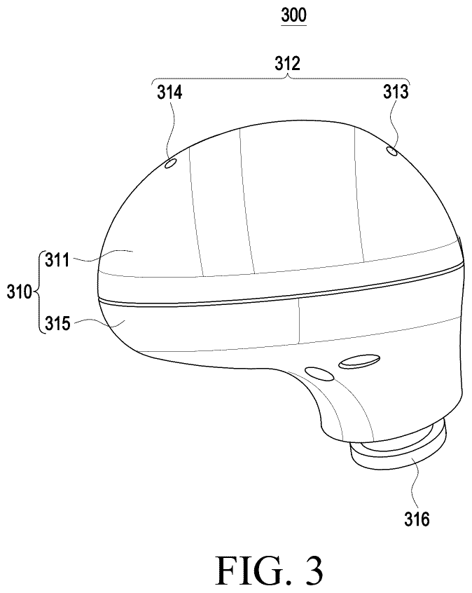

FIG. 3 is a side view illustrating an electronic device according to an embodiment of the disclosure.

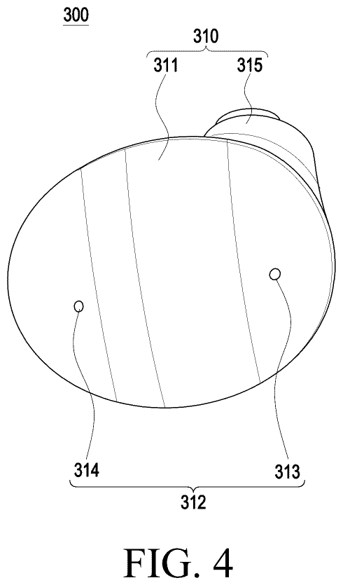

FIG. 4 is a top view illustrating the electronic device according to an embodiment of the disclosure.

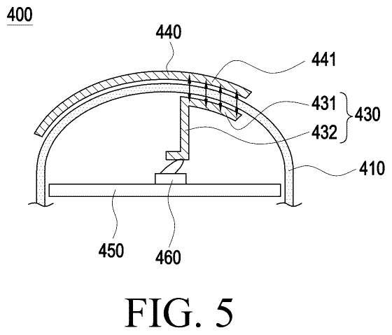

The embodiments of FIGS. 3 and 4 may be combined with the embodiments of FIGS. 1 and 2 or the embodiments of FIGS. 5 to 11.

Referring to FIGS. 3 and 4, an electronic device 300 (e.g., the electronic device 101 in FIG. 1) may include a housing 310 to accommodate components of the electronic device 300 therein. For example, acoustic components (e.g., the audio module 170 in FIGS. 1 and 2) and electronic components (e.g., the processor 120, the power management module 188, the battery 189, or the wireless communication module 192 in FIG. 1) may be disposed inside the housing 310. The configuration of the electronic device 300 in FIGS. 3 and 4 may be wholly or partially identical to that of the electronic device 101 in FIG. 1.

According to various embodiments of the disclosure, the electronic device 300 may include a wearable electronic device. The electronic device 300 may be wearable on a part of the body, such as an ear or the head. According to an embodiment of the disclosure, the electronic device 300 may include an in-ear earset, an in-ear headset, or a hearing aid.

According to various embodiments of the disclosure, the electronic device 300 may have an asymmetrical shape, as illustrated in FIGS. 3 and 4. According to an embodiment of the disclosure, as the electronic device 300 is formed to have an asymmetrical shape, it may be ergonomically designed and increase ease of use for a user. According to an embodiment of the disclosure, as the electronic device 300 is formed to have an asymmetrical shape, the acoustic components (e.g., the audio module 170 in FIG. 2) and the electronic components (e.g., the processor 120 in FIG. 1) may be disposed inside the housing 310 such that acoustic performance is improved.

According to an embodiment of the disclosure, the electronic device 300 may be electrically connected to an external electronic device (e.g., the external electronic device 102 in FIG. 1). According to an embodiment of the disclosure, the electronic device 300 may function as an audio output interface (or the sound output module 155 in FIG. 1) that outputs an acoustic signal received from the external electronic device 102.

Additionally or alternatively, the electronic device 300 of the disclosure may function as an audio input interface (or the input module 150 in FIG. 1) to receive an audio signal corresponding to sound obtained from the outside of the electronic device 300.

According to an embodiment of the disclosure, the electronic device 300 may also communicate with and/or be controlled by the external electronic device 102. The electronic device 300 may be an interactive electronic device which is paired with the external electronic device, such as a smartphone, through a communication scheme such as Bluetooth to convert data received from the external electronic device to output sound or to receive a user's voice and transmit it to the external electronic device.

According to an embodiment of the disclosure, the electronic device 300 may be wirelessly connected to the external electronic device 102 through a communication module (e.g., the communication module 190 in FIG. 1). For example, the electronic device 300 may communicate with the external electronic device 102 via a network (e.g., a short-range wireless communication network or a long-range wireless communication network). The network may include, but is not limited to, a mobile or cellular communication network, a local area network (LAN) (e.g., Bluetooth communication), a wireless local area network (WLAN), a wide area network (WAN), the Internet, or a small area network (SAN). According to an embodiment of the disclosure, the electronic device 300 may be wiredly connected to the external electronic device 102 via a cable (not shown).

According to another embodiment of the disclosure, the electronic device 300 may not communicate with the external electronic device 102. In this case, the electronic device 300 may be implemented to receive a signal corresponding to externally obtained sound and output an acoustic signal to the outside based on operations (or control) of components included in the electronic device 300, without being controlled by the external electronic device 102. For example, the electronic device 300 may be a stand-alone electronic device which plays music or a video on its own without communicating with the external electronic device 102 and outputs sound accordingly or which receives and processes the user's voice.

Various drawings of the disclosure may mainly illustrate a canal-type in-ear earset to be mounted in the ear canal extending from the auricle to the eardrum, as an example of the electronic device 300. However, it is to be noted that the disclosure is not limited thereto. According to another embodiment (not shown), the electronic device 300 may be described as an open-type earset to be mounted on the auricle.

According to various embodiments of the disclosure, the housing 310 may include a plurality of components. For example, the housing 310 may include a first housing 311 and a second housing 315 connected to the first housing 311. According to an embodiment of the disclosure, the first housing 311 and the second housing 315 may form at least a portion of the exterior of the electronic device 300 and form an internal space in which components of the electronic device 300 are accommodated. According to an embodiment of the disclosure, with the electronic device 300 worn on the user, at least a portion of the second housing 315 may contact or face the user's body (e.g., an ear), and at least a portion of the first housing 311 may face in the opposite direction of the user.

According to various embodiments of the disclosure, the housing 310 may include a microphone hole 312. According to an embodiment of the disclosure, the microphone hole 312 may be interpreted as a through hole formed on the first housing 311. According to an embodiment of the disclosure, sound from the outside of the electronic device 300 may pass through the microphone hole 312 and be transmitted to a microphone module (e.g., the input module 150 in FIG. 1) located inside the electronic device 300. According to an embodiment of the disclosure, the microphone hole 312 may include a plurality of microphone holes 313 and 314. For example, the microphone hole 312 may include a first microphone hole 313 and/or a second microphone hole 314 spaced apart from the first microphone hole 313.

According to various embodiments of the disclosure, the housing 310 may include a protruding portion 316. According to an embodiment of the disclosure, at least a portion of the protruding portion 316 may be inserted into the user's body (e.g., an ear). For example, the electronic device 300 may be inserted and mounted on the user's body (e.g., in an ear canal or auricle of the body) using the protruding portion 316. According to an embodiment of the disclosure, the protruding portion 316 may be interpreted as a portion of the housing 310 extending from the second housing 315. According to an embodiment of the disclosure, the protruding portion 316 may be further equipped with an ear tip (not shown), and the electronic device 300 may be brought into close contact with the user's ear using the ear tip. According to an embodiment of the disclosure, the protruding portion 316 may include at least one recess (not shown), and sound output from a speaker module (e.g., the sound output module 155 in FIG. 1, the audio module 170 in FIG. 1, or the audio module 170 in FIG. 2) disposed inside the electronic device 300 may be emitted to the outside of the electronic device 300 using the recess located on the protruding portion 316.

FIG. 5 is a diagram illustrating an antenna structure and a housing according to an embodiment of the disclosure.

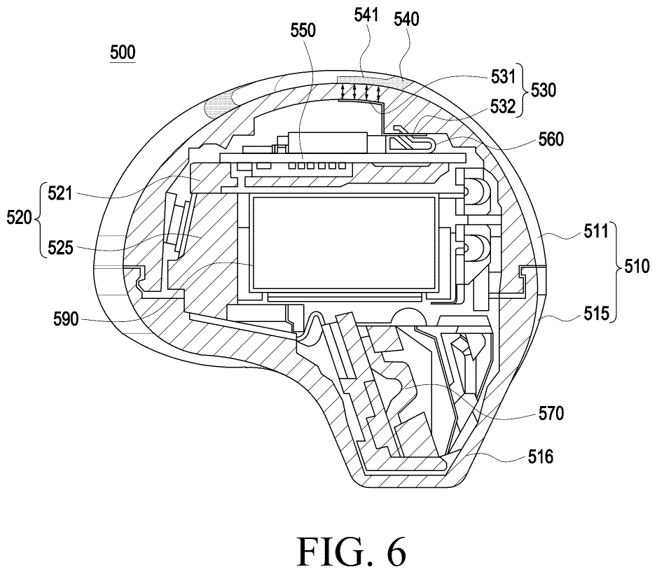

The embodiment of FIG. 5 may be combined with the embodiments of FIGS. 1 to 4 or the embodiments of FIGS. 6 to 11.

Referring to FIG. 5, an electronic device 300 (e.g., the electronic device 101 in FIG. 1 or the electronic device 300 in FIGS. 3 and 4) may include a housing 410, a circuit board 450, a first antenna pattern 430, a second antenna pattern 440, and/or a first connection member 460.

The configuration of the housing 410 in FIG. 5 may be partially or wholly identical to that of the housing 310 in FIGS. 3 and 4. The configuration of the first antenna pattern 430 and/or the second antenna pattern 440 in FIG. 5 may be partially or wholly identical to that of the antenna module 197 in FIG. 1.

According to various embodiments of the disclosure, the housing 410 (e.g., the housing 310 or the first housing 311 in FIGS. 3 and 4) may include a first surface (or outer surface) facing a first direction of the electronic device 400 (or facing the outside of the electronic device 400) and a second surface (or inner surface) facing a second direction (or facing the inner side or inside of the electronic device 400) different from the first direction. According to an embodiment of the disclosure, the housing 410 may form the exterior of the electronic device 400 and protect components disposed inside the housing 410.

According to various embodiments of the disclosure, the circuit board 450 may be disposed within the housing 410. According to an embodiment of the disclosure, the circuit board 450 may include at least one of a PCB, a flexible PCB (FPCB), or a rigid-flexible PCB (RFPCB). According to an embodiment of the disclosure, various components (e.g., the processor 120 or the memory 130 in FIG. 1) may be disposed or mounted on the circuit board 450.

According to various embodiments of the disclosure, the first antenna pattern 430 (or first antenna structure) may be disposed within the housing 410. According to an embodiment of the disclosure, the first antenna pattern 430 may be electrically connected to the circuit board 450. According to an embodiment of the disclosure, the first antenna pattern 430 may include a plated metal (e.g., copper (Cu) and/or nickel (Ni)). According to an embodiment of the disclosure, the first antenna pattern 430 may be referred to as a first antenna structure.

According to an embodiment of the disclosure, the first antenna pattern 430 may include a first portion 431 disposed adjacent to the second surface (or inner surface) of the housing 410 and a second portion 432 extending from the first portion 431.

According to an embodiment of the disclosure, the first portion 431 may extend from the second portion 432, and may be defined and/or interpreted as a portion extending to an area or space facing at least a portion 441 of the second antenna pattern 440 with the housing 410 interposed therebetween.

According to an embodiment of the disclosure, the second portion 432 may extend from the first portion 431, and the second portion 432 may extend from the inside of the housing 410 in a direction to connect to the circuit board 450. For example, the second portion 432 may extend from one end of the first portion 431 in the direction to connect to the circuit board 450 in an internal space of the housing 410. For example, when another structure (e.g., a support member or a separate housing) is disposed and/or provided inside the housing 410, the second portion 432 may extend in a direction or shape that connects to the circuit board 450 while avoiding the other structure. In another embodiment, the second portion 432 may be an antenna pattern formed on an exposed surface (e.g., outer surface) of another structure (e.g., a support member or a separate housing) disposed and/or provided inside the housing 410. In another embodiment, the second portion 432 formed on the other structure may be configured to be connected to the first portion 431 of the first antenna pattern 430.

In an embodiment, the first portion 431 and the second portion 432 may be an integrated antenna structure. In another embodiment, the first portion 431 and the second portion 432 may be separately formed and assembled or combined into an antenna structure. In some embodiments, the first portion 431 may be a laser direct structuring (LDS) antenna formed on the second surface (or inner surface) of the housing 410. For example, the first portion 431 may be an antenna pattern formed by a laser on the inner surface of the housing 410 formed of a thermoplastic resin (e.g., polycarbonate).

According to an embodiment of the disclosure, the second portion 432 may extend from the first portion 431 and be electrically connected to the circuit board 450 via the first connection member 460. In some embodiments (not shown), the second portion 432 may be electrically connected to the circuit board 450 directly without the first connection member 460.

According to various embodiments of the disclosure, the second antenna pattern 440 (or second antenna structure) may be disposed in a direction opposite to a direction in which the first antenna pattern 430 is disposed, with respect to the housing 410. For example, the first antenna pattern 430 may be disposed in an inward direction with respect to the housing 410, and the second antenna pattern 440 may be disposed in an outward direction with respect to the housing 410, which is opposite to the inward direction. According to various embodiments of the disclosure, the second antenna pattern 440 may be disposed on the first surface (or outer surface) of the housing 410. According to an embodiment of the disclosure, the second antenna pattern 440 may be configured to be electromagnetically coupled to the first antenna pattern 430. According to an embodiment of the disclosure, the second antenna pattern 440 may be an LDS antenna formed on the first surface (or outer surface) of the housing 410. For example, the second antenna pattern 440 may be an antenna pattern formed by a laser on the first surface (or outer surface) of the housing 410 formed of a thermoplastic resin (e.g., polycarbonate). Additionally, the second antenna pattern 440 may include a plated metal (e.g., copper (Cu) and/or nickel (Ni)). In an embodiment, the second antenna pattern 440 may be disposed or formed on the first surface (or outer surface) of the housing 410 to facilitate antenna radiation.

According to an embodiment of the disclosure, the first antenna pattern 430 and/or the second antenna pattern 440 may be disposed adjacent to the housing 410 of the electronic device 400 to ensure antenna radiation performance. Further, the first antenna pattern 430 and/or the second antenna pattern 440 may be disposed spaced apart from the circuit board 450 on which various electronic components including a processor (e.g., the processor 120 in FIG. 1 or a communications processor) or communication module (e.g., the communication module 190 in FIG. 1) for controlling the first antenna pattern 430 and/or the second antenna pattern 440, are disposed or mounted.

According to various embodiments of the disclosure, the first portion 431 of the first antenna pattern 430 may face the at least portion 441 of the second antenna pattern 440 with the housing 410 interposed therebetween. For example, when the electronic device 400 is viewed from the outside of the electronic device 400, the first portion 431 of the first antenna pattern 430 may be disposed overlapping the at least portion 441 of the second antenna pattern 440 with the housing 410 interposed therebetween. According to an embodiment of the disclosure, at least the first portion 431 of the first antenna pattern 430 may be disposed within a specified distance from the at least portion 441 of the second antenna pattern 440 such that an antenna signal may be transmitted. In an embodiment, the first portion 431 of the first antenna pattern 430 may be disposed within a specified distance of the at least portion 441 of the second antenna pattern 440. In an embodiment, the first portion 431 of the first antenna pattern 430 may be disposed at a distance from the at least portion 441 of the second antenna pattern 440, which is greater than the thickness of the housing 410, equal to the thickness of the housing 410, or less than the thickness of the housing 410. When the first portion 431 of the first antenna pattern 430 is disposed at a distance less than the thickness of the housing 410 from the at least portion 441 of the second antenna pattern 440, at least one of the first portion 431 of the first antenna pattern 430 or the at least portion 441 of the second antenna pattern 440 may be disposed in a recess formed on the second surface (or inner surface) of the housing 410 or in a recess formed on the first surface (or outer surface) of the housing 410. According to an embodiment of the disclosure, when the electronic device 400 is viewed from the outside of the electronic device 400, the first portion 431 of the first antenna pattern 430 may be disposed to overlap the at least portion 441 of the second antenna pattern 440 by a specified length, a specified distance, or a specified area with the housing 410 interposed therebetween.

According to an embodiment of the disclosure, an antenna signal generated by the processor (e.g., the processor 120 in FIG. 1 or the communication processor) and/or the communication module (e.g., the communication module 190 in FIG. 1) may be transmitted to the second portion 432 of the first antenna pattern 430 via the circuit board 450 and/or the first connection member 460. The antenna signal transmitted to the second portion 432 of the first antenna pattern 430 may be transmitted to the second antenna pattern 440 via the first portion 431 of the first antenna pattern 430. For example, the first portion 431 of the first antenna pattern 430 may be electromagnetically coupled to the at least portion 441 of the second antenna pattern 440, such that the antenna signal may radiate to the outside of the electronic device 400 via the second antenna pattern 440 through a capacitance formed between coupled portions.

According to an embodiment of the disclosure, as the second antenna pattern 440 is spaced apart from the user's ear or the circuit board 450 of the electronic device 400, which may generate interference with antenna radiation performance, the performance of antenna radiation through the second antenna pattern 440 may be improved.

According to an embodiment of the disclosure, the first connection member 460 may include, but is not limited to, a c-clip. For example, the first connection member 460 may include various types of members that electrically connect one component to another, such as a conductive wire or a pogo pin.

FIG. 6 is a cross-sectional view illustrating an electronic device according to an embodiment of the disclosure.

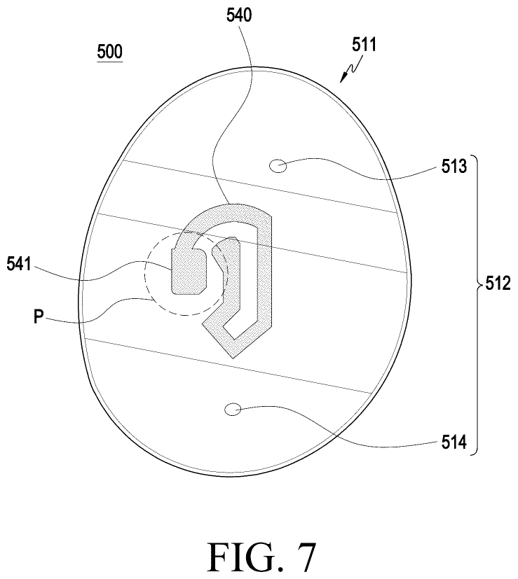

FIG. 7 is a top view illustrating a first housing according to an embodiment of the disclosure.

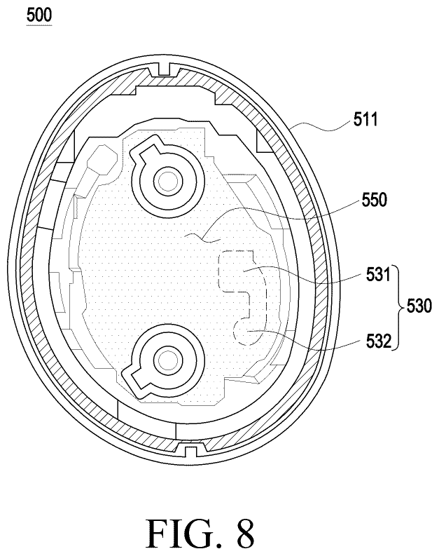

FIG. 8 is a bottom view illustrating the first housing according to an embodiment of the disclosure.

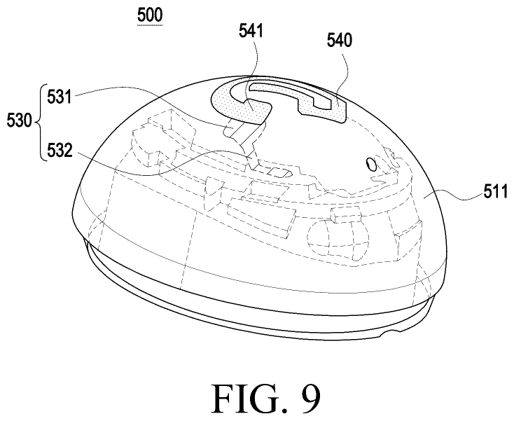

FIG. 9 is a perspective view illustrating the first housing according to an embodiment of the disclosure.

FIG. 7 is a diagram illustrating the first housing viewed from above the first housing, and FIG. 8 is a diagram illustrating the first housing from a direction opposite to the direction in FIG. 7. FIG. 8 illustrates the first housing, a circuit board, and a first antenna pattern electrically connected to the circuit board.

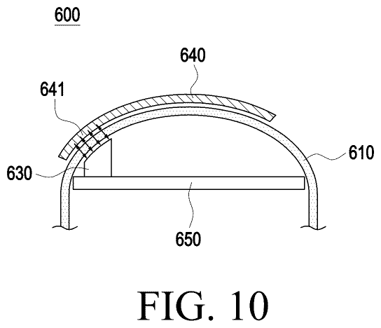

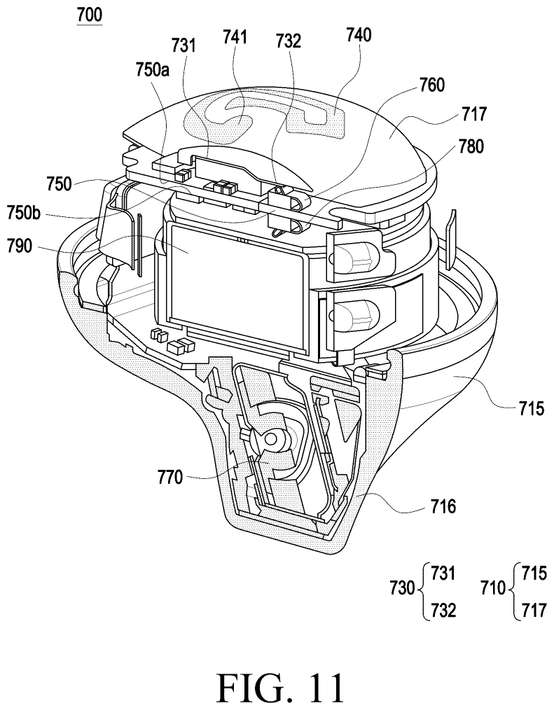

The embodiments of FIGS. 6 to 9 may be combined with the embodiments of FIGS. 1 to 5 or the embodiments of FIGS. 10 and 11.

Referring to FIGS. 6 to 9, an electronic device 500 (e.g., the electronic device 101 of FIG. 1, the electronic device 300 in FIGS. 3 and 4, or the electronic device 400 in FIG. 5) may include a housing 510, a support member 520, a first antenna pattern 530, a second antenna pattern 540, a circuit board 550, a first connection member 560, a sound output module 570, and/or a battery 590.

The configuration of the housing 510 in FIGS. 6 to 9 may be partially or wholly identical to that of the housing 310 in FIGS. 3 and 4 or the housing 410 in FIG. 5. The configuration of the first antenna pattern 530, the second antenna pattern 540, the circuit board 550, and/or the first connection member 560 in FIGS. 6 to 9 may be partially or wholly identical to that of the first antenna pattern 430, the second antenna pattern 440, the circuit board 450, and/or the first connection member 460 in FIG. 5. The configuration of the sound output module 570 in FIGS. 6 to 9 may be partially or wholly identical to that of the sound output module 155 in FIG. 1. The configuration of the battery 590 in FIGS. 6 to 9 may be partially or wholly identical to that of the battery 189 in FIG. 1.

According to various embodiments of the disclosure, the housing 510 (e.g., the housing 310 in FIGS. 3 and 4 or the housing 410 in FIG. 5) may include a first housing 511 (e.g., the first housing 311 in FIGS. 3 and 4) and a second housing 515 (e.g., the second housing 315 in FIGS. 3 and 4) coupled or connected to the first housing 511.

According to an embodiment of the disclosure, the first housing 511 and the second housing 515 may be formed as separate members and assembled. According to some embodiments, the first housing 511 and the second housing 515 may be formed integrally. According to an embodiment of the disclosure, the electronic device 500 may have various components disposed or mounted in an internal space formed by coupling or connecting the first housing 511 and the second housing 515 to each other. According to an embodiment of the disclosure, the second housing 515 may include a protruding portion 516 (e.g., the protruding portion 316 in FIGS. 3 and 4). Referring to FIG. 7, the first housing 511 may include a microphone hole 512 (e.g., the microphone hole 312 in FIG. 4) that includes a first microphone hole 513 (e.g., the first microphone hole 313 in FIG. 4) and/or a second microphone hole 514 (e.g., the second microphone hole 314 in FIG. 4).

According to an embodiment of the disclosure, the first housing 511 may include a first surface (or outer surface) facing a first direction (or an outward direction of the electronic device 500) and a second surface (or inner surface) facing a second direction (or the inner side or inside of the electronic device 500) different from the first direction.

According to an embodiment of the disclosure, the first antenna pattern 530 (e.g., the first antenna pattern 430 in FIG. 5) (or first antenna structure) may include a first portion 531 (e.g., the first portion 431 in FIG. 5) disposed adjacent to the second surface (or inner surface) of the housing 510 (e.g., the second surface (or inner surface) of the first housing 511) and a second portion 532 (e.g., the second portion 432 in FIG. 5) extending from the first portion 531. In an embodiment, the second portion 532 may be electrically connected to the circuit board 550 (e.g., the circuit board 550 in FIG. 5) via the first connection member 560 (e.g., the first connection member 460 in FIG. 5).

According to an embodiment of the disclosure, the first portion 531 and the second portion 532 of the first antenna pattern 530 may be disposed adjacent to or in close contact with the second surface (or inner surface) of the first housing 511. According to an embodiment of the disclosure, a separation distance between the first portion 531 of the first antenna pattern 530 and the circuit board 550 may be greater than a separation distance between the second portion 532 of the first antenna pattern 530 and the circuit board 550.

Referring to FIG. 6, the second antenna pattern 540 (e.g., the second antenna pattern 440 in FIG. 5) (or second antenna structure) may be formed on the first surface (or outer surface) of the first housing 511. In the illustrated embodiment, the second antenna pattern 540 may have, but is not limited to, a ring shape in which the second antenna pattern 540 is at least partially curled to obtain a resonant length of an antenna in a limited area. At least a portion 541 of the second antenna pattern 540 may be defined as a touch area P. For example, the at least portion 541 of the second antenna pattern 540 may be electromagnetically coupled to the first portion 531 of the first antenna pattern 530, such that a capacitance is formed between the two portions. When the user touches the touch area P, the value of the capacitance formed between the at least portion 541 of the second antenna pattern 540 and the first portion 531 of the first antenna pattern 530 may change, which is sensed by the processor (e.g., the processor 120 in FIG. 1), allowing the user to input a touch signal to the electronic device 500. According to an embodiment of the disclosure, the electronic device 500 may implement a button touch function via the touch area P without the need for a physical button.

According to an embodiment of the disclosure, the first antenna pattern 530 may be an LDS antenna formed on the second surface (or inner surface) of the first housing 511. In an embodiment, the second antenna pattern 540 may be an LDS antenna formed on the first surface (or outer face) of the first housing 511.

According to various embodiments of the disclosure, the circuit board 550 (e.g., the circuit board 450 in FIG. 5) may be disposed within the housing 510. According to an embodiment of the disclosure, the circuit board 550 may be electrically connected to the second portion 532 of the first antenna pattern 530 via the first connection member 560 (e.g., the first connection member 460 in FIG. 5). According to an embodiment of the disclosure, the circuit board 550 may be electrically connected to the battery 590 (e.g., the battery 589 in FIG. 1) via a separate wire or substrate (e.g., FPCB).

According to various embodiments of the disclosure, the electronic device 500 may further include the support member 520. The support member 520 may be disposed in an internal space formed by the housing 510 and configured to support components disposed inside the housing 510. In an embodiment, the support member 520 may include a first support member 521 supporting the circuit board 550 and a second support member 525 supporting the battery 590. The first support member 521 and the second support member 525 may be formed as, but are not limited to, separate members. The first support member 521 and the second support member 525 may be formed integrally.

According to various embodiments of the disclosure, the battery 590 may be disposed within the housing 510 and supply power to components (e.g., the circuit board 550, the sound output module 570, or the processor) of the electronic device 500.

According to various embodiments of the disclosure, the sound output module 570 (e.g., the sound output module 155 in FIG. 1) may be disposed within the housing 510. According to an embodiment of the disclosure, the sound output module 570 may be a speaker module disposed adjacent to the protruding portion 516. In an embodiment, sound generated from the sound output module 570 may be transmitted to the user's ear through a hole (not shown) or recess (not shown) formed on the protruding portion 516.

Referring to FIGS. 8 and 9, the first antenna pattern 530 is disposed inside the first housing 511 and indicated by a dotted line to facilitate identification of the position of the first antenna pattern 530 inside the first housing 511.

According to an embodiment of the disclosure, the first portion 531 of the first antenna pattern 530 may be electromagnetically coupled to the at least portion 541 of the second antenna pattern 540, such that a capacitance may be formed between the two portions. Additionally, an antenna signal from the circuit board 550 may be transmitted to and radiated from the second antenna pattern 540 via the first connection member 560 and the first antenna pattern 530. According to an embodiment of the disclosure, the second antenna pattern 540 may face a direction opposite to the protruding portion 516.

According to an embodiment of the disclosure, as the first antenna pattern 530 and the second antenna pattern 540 are electromagnetically coupled to each other, the first antenna pattern 530 and the second antenna pattern 540 may be electromagnetically connected to each other without the need for a separate connection structure (e.g., via) in the first housing 511. Further, since the separate connection structure (e.g., via) is not formed in the first housing 511, sufficient rigidity of the first housing 511 may be secured.

FIG. 10 is a diagram illustrating an antenna structure and a housing according to an embodiment of the disclosure.

The embodiment of FIG. 10 may be combined with the embodiments of FIGS. 1 to 9 or the embodiment of FIG. 11.

Referring to FIG. 10, an electronic device 600 (e.g., the electronic device 101 in FIG. 1 or the electronic device 300 in FIGS. 3 and 4) may include a housing 610, a circuit board 650, a first antenna structure 630, and/or a second antenna structure 640.

The configuration of the housing 610 in FIG. 10 may be partially or wholly identical to that of the housing 310 in FIGS. 3 and 4. The configuration of the first antenna structure 630 and/or the second antenna structure 640 in FIG. 10 may be partially or wholly identical to that of the antenna module 197 in FIG. 1. The configuration of the first antenna structure 630 and/or the second antenna structure 640 in FIG. 10 may be partially or wholly identical to that of the first antenna pattern 430 and/or the second antenna pattern 440 in FIG. 5 or that of the first antenna pattern 530 and/or the second antenna pattern 540 in FIGS. 6 to 9. In an embodiment, the first antenna structure 630 may be referred to as a first antenna pattern, and the second antenna structure 640 may be referred to as a second antenna pattern.

According to various embodiments of the disclosure, the housing 610 (e.g., the housing 310 or the first housing 311 in FIGS. 3 and 4) may include a first surface (or outer surface) facing a first direction (or the outside of the electronic device 600) and a second surface (or inner surface) facing a second direction (or the inner side or inside of the electronic device 600) different from the first direction. According to an embodiment of the disclosure, the housing 610 may form the exterior of the electronic device 600 and protect components disposed inside the housing 610.

According to various embodiments of the disclosure, the circuit board 650 may be disposed within the housing 610. According to an embodiment of the disclosure, the circuit board 650 may include at least one of a PCB, an FPCB, or an RFPCB. According to an embodiment of the disclosure, various components (e.g., the processor 120 or memory 130 in FIG. 1) may be disposed or mounted on the circuit board 650.

According to various embodiments of the disclosure, the first antenna structure 630 (or first antenna pattern) may include a gasket member and a conductive portion formed on the gasket member. According to various embodiments of the disclosure, the first antenna structure 630 may be disposed within the housing 610 and electrically connected to the circuit board 650. According to an embodiment of the disclosure, the conductive portion of the first antenna structure 630 may include a metal (e.g., copper (Cu) and/or nickel (Ni)). According to an embodiment of the disclosure, the first antenna structure 630 may be disposed in a corner formed between the housing 610 and the circuit board 650. The conductive portion of the first antenna structure 630 may be exposed from a surface of the gasket member (e.g., a surface facing the housing 610), and the exposed conductive portion may be electromagnetically coupled to at least a portion 641 of the second antenna structure 640. Further, the conductive portion of the first antenna structure 630 may be electrically connected to the circuit board 650. According to an embodiment of the disclosure, an antenna signal from the circuit board 650 may be transmitted to and radiated from the second antenna structure 640 through the conductive portion of the first antenna structure 630.

According to various embodiments of the disclosure, the second antenna structure 640 (or second antenna pattern) may be disposed on the first surface (or outer surface) of the housing 610. According to an embodiment of the disclosure, the second antenna structure 640 may be configured to be electromagnetically coupled to the first antenna structure 630 (e.g., the conductive portion of the first antenna structure 630). According to an embodiment of the disclosure, the second antenna structure 640 may be an LDS antenna formed on the first surface (or outer surface) of the housing 610. For example, the second antenna structure 640 may be an antenna pattern structure formed by a laser on the first surface (or outer surface) of the housing 610 formed of a thermoplastic resin (e.g., polycarbonate). Additionally, the second antenna structure 640 may include a plated metal (e.g., copper (Cu) and/or nickel (Ni)). In an embodiment, the second antenna structure 640 may be disposed or formed on the outer surface of the housing 610 to facilitate antenna radiation.

According to an embodiment of the disclosure, the first antenna structure 630 and/or the second antenna structure 640 may be disposed adjacent to the housing 610 of the electronic device 600 to ensure antenna radiation performance. Further, the first antenna structure 630 and/or the second antenna structure 640 may be spaced apart from the circuit board 650 on which various electronic components including a processor (e.g., the processor 120 in FIG. 1 or the communication processor) or communication module (e.g., the communication module 190 in FIG. 1) for controlling the first antenna structure 630 and/or the second antenna structure 640, are disposed or mounted.

According to various embodiments of the disclosure, at least a portion of its conductive portion of the first antenna structure 630 may face the at least portion 641 of the second antenna structure 640 with the housing 610 interposed therebetween. For example, when the electronic device 600 is viewed from the outside of the electronic device 600, the at least portion of the conductive portion of the first antenna structure 630 may overlap the at least portion 641 of the second antenna structure 640 with the housing 610 interposed therebetween.

According to an embodiment of the disclosure, an antenna signal generated by the processor (e.g., the processor 120 in FIG. 1 or the communication processor) and/or the communication module (e.g., the communication module 190 in FIG. 1) may be transmitted to the conductive portion of the first antenna structure 630 via the circuit board 650. Further, the antenna signal transmitted to the conductive portion of the first antenna structure 630 may be transmitted to the second antenna structure 640 via the conductive portion exposed from the gasket member. For example, the conductive portion of the first antenna structure 630 may be electromagnetically coupled to the at least portion 641 of the second antenna structure 640, such that the antenna signal may radiate to the outside of the electronic device 600 via the second antenna structure 640 through a capacitance formed between the coupled portions.

According to an embodiment of the disclosure, the performance of antenna radiation through the second antenna structure 640 may be improved by spacing the second antenna structure 640 apart from the user's ear or the circuit board 650 of the electronic device 600 that may generate interference with the antenna radiation performance.

FIG. 11 is a cross-sectional perspective view illustrating an electronic device according to an embodiment of the disclosure.

The embodiment of FIG. 11 may be combined with the embodiments of FIGS. 1 to 10.

Referring to FIG. 11, an electronic device 700 (e.g., the electronic device 101 in FIG. 1, the electronic device 300 in FIGS. 3 and 4, or the electronic device 400 in FIG. 5) may include a housing 710, a first antenna pattern 730, a second antenna pattern 740, a circuit board 750, a first connection member 760, a sound output module 770, a second connection member 780, and/or a battery 790.

The configuration of the housing 710 in FIG. 11 may be partially or wholly identical to that of the housing 310 in FIGS. 3 and 4 or the housing 410 in FIG. 5. The configuration of the first antenna pattern 730, the second antenna pattern 740, the circuit board 750, and/or the first connection member 760 in FIG. 11 may be partially or wholly identical to that of the first antenna pattern 430, the second antenna pattern 440, the circuit board 450, and/or the first connection member 460 in FIG. 5. The configuration of the sound output module 770 in FIG. 11 may be partially or wholly identical to that of the sound output module 155 in FIG. 1. The configuration of the battery 790 in FIG. 11 may be partially or wholly identical to that of the battery 189 in FIG. 1.

According to various embodiments of the disclosure, the housing 710 (e.g., the housing 310 in FIGS. 3 and 4 or the housing 410 in FIG. 5) may include a first housing (e.g., the first housing 311 of FIGS. 3 and 4), a second housing 715 (e.g., the second housing 715 in FIGS. 3 and 4) coupled or connected to the first housing (e.g., the first housing 311 in FIGS. 3 and 4), and a third housing 717 disposed in an internal space formed between the first housing and the second housing 715.

According to an embodiment of the disclosure, the first housing (e.g., the first housing 311 in FIGS. 3 and 4) and the second housing 715 may be formed as separate members and assembled. According to some embodiments, the first housing and the second housing 715 may be formed integrally. According to an embodiment of the disclosure, the electronic device 700 may have various components disposed or mounted in an internal space formed by coupling or connecting the first housing and the second housing 715 to each other. According to an embodiment of the disclosure, the second housing 715 may include a protruding portion 716 (e.g., the protruding portion 316 in FIGS. 3 and 4). The third housing 717 may be disposed in an internal space formed by coupling the first housing and the second housing 715 to each other. The third housing 717 may include a first surface (or outer surface) facing a first direction (or the outside of the electronic device 700 or the first housing) and a second surface (or inner surface) facing a second direction (or facing the inner side or inside of the electronic device 700 or facing the circuit board 750) different from the first direction. According to an embodiment of the disclosure, the outer surface of the third housing 717 may be covered by the first housing.

According to an embodiment of the disclosure, the first antenna pattern 730 (e.g., the first antenna pattern 430 in FIG. 5) (or first antenna structure) may include a first portion 731 (e.g., the first portion 431 in FIG. 5) disposed adjacent to the second surface (or inner surface) of the third housing 717 and a second portion 732 (e.g., the second portion 432 in FIG. 5) extending from the first portion 731. In an embodiment, the second portion 732 may be electrically connected to a third surface 750a of the circuit board 750 (e.g., the circuit board 750 in FIG. 5) via the first connection member 760 (e.g., the first connection member 460 in FIG. 5).

According to an embodiment of the disclosure, the first portion 731 and the second portion 732 of the first antenna pattern 730 may be disposed adjacent to or in close contact with the second surface (or inner surface) of the third housing 717. According to an embodiment of the disclosure, a separation distance between the first portion 731 of the first antenna pattern 730 and the circuit board 750 may be greater than a separation distance between the second portion 732 of the first antenna pattern 730 and the circuit board 750.

The second antenna pattern 740 (e.g., the second antenna pattern 440 in FIG. 5) (or second antenna structure) may be formed on the first surface (or outer face) of the third housing 717. According to the illustrated embodiment, the second antenna pattern 740 may have, but is not limited to, a ring shape in which the second antenna pattern 740 is at least partially curled to obtain a resonant length of an antenna in a limited area.

According to some embodiments, the third housing 717 may have the second antenna pattern 740 formed on the first surface (or outer surface), and with the second antenna pattern 740 formed, the third housing 717 may be bonded to or assembled with the first housing (e.g., the first housing 311 in FIGS. 3 and 4), thereby forming an integrated housing member.

At least a portion 741 of the second antenna pattern 740 may be electromagnetically coupled to the first portion 731 of the first antenna pattern 730, such that a capacitance may be formed between the two portions.

According to an embodiment of the disclosure, the first antenna pattern 730 may be an LDS antenna formed on the second surface (or inner surface) of the third housing 717. In an embodiment, the second antenna pattern 740 may be an LDS antenna formed on the first surface (or outer face) of the third housing 717.

According to various embodiments of the disclosure, the circuit board 750 (e.g., the circuit board 450 in FIG. 5) may be disposed within the housing 710. According to an embodiment of the disclosure, the circuit board 750 may be electrically connected to the second portion 732 of the first antenna pattern 730 via the first connection member 760 (e.g., the first connection member 460 in FIG. 5). According to an embodiment of the disclosure, the circuit board 750 may be electrically connected to the battery 790 (e.g., the battery 789 in FIG. 1) via a separate wire or substrate (e.g., FPCB). According to an embodiment of the disclosure, the circuit board 750 may include the third surface 750a facing the first antenna pattern 730 and the second antenna pattern 740 and a fourth surface 750b facing a direction opposite to the third surface 750a. In an embodiment, the first connection member 760 may electrically connect the third surface 750a of the circuit board 750 to the first antenna pattern 730.

According to various embodiments of the disclosure, the battery 790 may be disposed within the housing 710 and supply power to components (e.g., the circuit board 750, the sound output module 770, or the processor) of the electronic device 700.

According to various embodiments of the disclosure, the sound output module 770 (e.g., the sound output module 155 in FIG. 1) may be disposed within the housing 710. According to an embodiment of the disclosure, the sound output module 770 may be a speaker module disposed adjacent to the protruding portion 716. In an embodiment, sound generated from the sound output module 770 may be transmitted to the user's ear through a hole (not shown) or recess (not shown) formed on the protruding portion 716.

According to an embodiment of the disclosure, the first portion 731 of the first antenna pattern 730 may be electromagnetically coupled to the at least portion 741 of the second antenna pattern 740, such that a capacitance may be formed between the two portions. Additionally, an antenna signal from the circuit board 750 may be transmitted to and radiated from the second antenna pattern 740 via the first connection member 760 and the first antenna pattern 730. According to an embodiment of the disclosure, the second antenna pattern 740 may face a direction opposite to the protruding portion 716.

According to an embodiment of the disclosure, as the first antenna pattern 730 and the second antenna pattern 740 are electromagnetically coupled to each other, the first antenna pattern 730 and the second antenna pattern 740 may be electromagnetically connected to each other without the need for a separate connection structure (e.g., via) in the third housing 717. Further, since the separate connection structure (e.g., via) is not formed in the third housing 717, sufficient rigidity of the third housing 717 may be ensured.

According to an embodiment of the disclosure, as the second antenna pattern 740 is covered by the first housing (e.g., the first housing 311 in FIGS. 3 and 4), the second antenna pattern 740 may not be exposed to the outside of the electronic device 700.

According to an embodiment of the disclosure, the electronic device 700 may further include the second connection member 780. The second connection member 780 may electrically connect the battery 790 to the circuit board 750. For example, the second connection member 780 may have one side electrically connected to the fourth surface 750b of the circuit board 750 and the other side electrically connected to the battery 790. According to an embodiment of the disclosure, the battery 790 may supply power to the circuit board 750 via the second connection member 780.

According to an embodiment of the disclosure, the second connection member 780 may include, but is not limited to, a c-clip. For example, the second connection member 780 may include various other types of members that electrically connect one component to another, such as a conductive wire or a pogo pin.

According to various embodiments of the disclosure, an electronic device (e.g., the electronic device 101 in FIG. 1, the electronic device 300 in FIG. 4, the electronic device 400 in FIG. 5, or the electronic device 500 in FIG. 6) may include: a housing (e.g., the housing 410 in FIGS. 3 and 4, the housing 510 in FIG. 5, or the housing 610 in FIG. 6) including a first surface facing a first direction and a second surface facing a second direction different from the first direction; a sound output module (e.g., the sound output module 155 in FIG. 1 or the sound output module 570 in FIG. 6) disposed within the housing; a circuit board (e.g., the circuit board 450 in FIG. 5 or the circuit board 550 in FIG. 6) disposed within the housing; a first antenna pattern (e.g., the first antenna pattern 430 in FIG. 5 or the first antenna pattern 530 in FIG. 6) disposed within the housing and electrically connected to the circuit board; and a second antenna pattern (e.g., the second antenna pattern 440 in FIG. 5 or the second antenna pattern 540 in FIG. 6) disposed on the first surface of the housing and configured to be electromagnetically coupled to the first antenna pattern. The first antenna pattern may include a first portion (e.g., the first portion 431 in FIG. 5 or the first portion 531 in FIG. 6) disposed adjacent to the second surface of the housing and a second portion (e.g., the second portion 432 in FIG. 5 or the second portion 532 in FIG. 6) extending from the first portion, and the first portion of the first antenna pattern may face at least a portion (e.g., 441 in FIG. 5 or 541 in FIG. 6) of the second antenna pattern with the housing interposed therebetween.

According to various embodiments of the disclosure, the electronic device may further include a first connection member (e.g., the first connection member 460 in FIG. 5 or the first connection member 560 in FIG. 6) electrically connecting the second portion of the first antenna pattern and the circuit board.

According to various embodiments of the disclosure, the first connection member may include at least one of a c-clip, a conductive wire, or a pogo pin.

According to various embodiments of the disclosure, the housing may include a first housing (e.g., the first housing 511 in FIG. 6) and a second housing (e.g., the second housing 515 in FIG. 6) coupled to the first housing, the first housing may include the first surface and the second surface, the first antenna pattern may be disposed on the second surface of the first housing, and the second antenna pattern may be disposed on the first surface of the first housing.

According to various embodiments of the disclosure, the second housing may include a protruding portion (e.g., the protruding portion 516 in FIG. 6) formed to protrude from at least a portion of the second housing, and the second antenna pattern may be spaced apart from the protruding portion and face a direction opposite to the protruding portion.

According to various embodiments of the disclosure, the sound output module may be disposed in the protruding portion.

According to various embodiments of the disclosure, the first portion of the first antenna pattern may be spaced apart from the circuit board.

According to various embodiments of the disclosure, a separation distance between the first portion of the first antenna pattern and the circuit board may be greater than a separation distance between the second portion of the first antenna pattern and the circuit board.

According to various embodiments of the disclosure, the at least portion (e.g., the at least portion 541 in FIG. 4) of the second antenna pattern may form a touch area (e.g., the touch area P in FIG. 7) configured to detect a touch input from a user.

According to various embodiments of the disclosure, the first antenna pattern may be a laser direct structuring (LDS) antenna formed on the second surface of the housing.

According to various embodiments of the disclosure, the second antenna pattern may be a laser direct structuring (LDS) antenna formed on the first surface of the housing.

According to various embodiments of the disclosure, the electronic device may further include a gasket (e.g., the gasket member of the first antenna structure 630 in FIG. 10) disposed between the circuit board and the housing and including the first antenna pattern.

According to various embodiments of the disclosure, the gasket may be disposed adjacent to a corner formed by the circuit board (e.g., the circuit board 650 in FIG. 10) and the housing (e.g., the housing 610 in FIG. 10).

According to various embodiments of the disclosure, the electronic device may further include a battery (e.g., the battery 790 in FIG. 11) disposed within the housing, and a second connection member (e.g., the second connection member 780 in FIG. 11) electrically connecting the circuit board and the battery.

According to various embodiments of the disclosure, the housing (e.g., the housing 710 in FIG. 11) includes a first housing (e.g., the first housing 511 in FIG. 6), a second housing (e.g., the second housing 515 in FIG. 11) coupled to the first housing, and a third housing (e.g., the third housing 717 in FIG. 11) disposed in an internal space formed between the first housing and the second housing, the third housing may include the first surface and the second surface, the first surface of the third housing may face the first housing, the first antenna pattern may be disposed on the second surface of the third housing, and the second antenna pattern may be disposed on the first surface of the third housing.

According to various embodiments of the disclosure, an electronic device (e.g., the electronic device 101 in FIG. 1, the electronic device 300 in FIG. 4, the electronic device 400 in FIG. 5, or the electronic device 500 in FIG. 6) may include: a housing (e.g., the housing 410 in FIGS. 3 and 4 or the housing 510 in FIG. 5) including a first surface facing a first direction and a second surface facing a second direction different from the first direction; a sound output module (e.g., the sound output module 155 in FIG. 1 or the sound output module 570 in FIG. 6) disposed within the housing; a circuit board (e.g., the circuit board 450 in FIG. 5 or the circuit board 550 in FIG. 6) disposed within the housing; a first antenna structure (e.g., the first antenna pattern 430 in FIG. 5, the first antenna pattern 530 in FIG. 6, or the first antenna structure 630 in FIG. 10) disposed within the housing and electrically connected to the circuit board; and a second antenna structure (e.g., the second antenna pattern 440 in FIG. 5, the second antenna pattern 540 in FIG. 6, or the second antenna structure 640 in FIG. 10)) disposed on the first surface of the housing and configured to be electromagnetically coupled to the first antenna pattern. The first antenna structure may be disposed adjacent to the second surface of the housing, and at least a portion of the first antenna structure may face at least a portion of the second antenna structure with the housing interposed therebetween. The second antenna structure may be a laser direct structuring (LDS) antenna formed on the first surface of the housing.

According to various embodiments of the disclosure, the at least portion of the first antenna structure may be formed as a conductive portion.

According to various embodiments of the disclosure, the housing (e.g., the housing 710 in FIG. 6 or the first housing 511 in FIG. 7) may include a first hole (e.g., the first microphone hole 513 in FIG. 7) and a second hole (e.g., the second microphone hole 514 in FIG. 7) spaced apart from the first hole, and the second antenna structure (e.g., the second antenna pattern 540 in FIG. 7) may be disposed between the first hole and the second hole.

According to various embodiments of the disclosure, the circuit board (e.g., the circuit board 450 in FIG. 5, the circuit board 550 in FIG. 6, the circuit board 650 in FIG. 10, or the circuit board 750 in FIG. 11) may include a third surface (e.g., the third surface 750a in FIG. 11) facing the first antenna structure and the second antenna structure and a fourth surface (e.g., the fourth surface 750b in FIG. 11) facing a direction opposite to the third surface, and the electronic device further include a first connection member (e.g., the first connection member 460 in FIG. 5, the first connection member 560 in FIG. 6, or the first connection member 760 in FIG. 11) electrically connecting the third surface of the circuit board to the first antenna structure.

According to various embodiments of the disclosure, an electronic device (e.g., the electronic device 101 in FIG. 1 or the electronic device 500 in FIG. 6) may include: a housing (e.g., the housing 510 in FIG. 6) including a first housing (e.g., the first housing 511 in FIG. 6) including a first surface facing a first direction and a second surface facing a second direction different from the first direction, and a second housing (e.g., the second housing 515 in FIG. 6) coupled to the first housing; a sound output module (e.g., the sound output module 570 in FIG. 6) disposed within the housing; a circuit board (e.g., the circuit board 550 in FIG. 6) disposed within the housing; a first antenna pattern (e.g., the first antenna pattern 530 in FIG. 6) disposed within the housing and electrically connected to the circuit board; and a second antenna pattern (e.g., the second antenna pattern 540 in FIG. 6) disposed on the first surface of the housing and configured to be electromagnetically coupled to the first antenna pattern. At a least portion (e.g., the first portion 531 in FIG. 6) of the first antenna pattern may face at least a portion (e.g., the at least portion 541 in FIG. 6) of the second antenna pattern with the housing interposed therebetween.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a housing including a first surface facing a first direction and a second surface facing a second direction different from the first direction;
a sound output module disposed within the housing;
a circuit board disposed within the housing;
a first antenna pattern disposed within the housing and electrically connected to the circuit board; and
a second antenna pattern disposed on the first surface of the housing and configured to be electromagnetically coupled to the first antenna pattern,
wherein the first antenna pattern includes a first portion disposed adjacent to the second surface of the housing and a second portion extending from the first portion, and
wherein the first portion of the first antenna pattern faces at least a portion of the second antenna pattern with the housing interposed therebetween.

2. The electronic device of claim 1, further comprising:
a first connection member electrically connecting the second portion of the first antenna pattern and the circuit board.

3. The electronic device of claim 2, wherein the first connection member includes at least one of a c-clip, a conductive wire, or a pogo pin.

4. The electronic device of claim 1,
wherein the housing includes a first housing and a second housing coupled to the first housing,
wherein the first housing includes the first surface and the second surface,
wherein the first antenna pattern is disposed on the second surface of the first housing, and
wherein the second antenna pattern is disposed on the first surface of the first housing.

5. The electronic device of claim 4,
wherein the second housing includes a protruding portion formed to protrude from at least a portion of the second housing, and
wherein the second antenna pattern is spaced apart from the protruding portion and faces a direction opposite to the protruding portion.

6. The electronic device of claim 5, wherein the sound output module is disposed in the protruding portion.

7. The electronic device of claim 1, wherein the first portion of the first antenna pattern is spaced apart from the circuit board.

8. The electronic device of claim 7, wherein a separation distance between the first portion of the first antenna pattern and the circuit board is greater than a separation distance between the second portion of the first antenna pattern and the circuit board.

9. The electronic device of claim 1, wherein the at least portion of the second antenna pattern forms a touch area configured to detect a touch input from a user.

10. The electronic device of claim 1, wherein the first antenna pattern is a laser direct structuring (LDS) antenna formed on the second surface of the housing.

11. The electronic device of claim 1, wherein the second antenna pattern is a laser direct structuring (LDS) antenna formed on the first surface of the housing.

12. The electronic device of claim 1, further comprising:
a gasket disposed between the circuit board and the housing and including the first antenna pattern.

13. The electronic device of claim 12, wherein the gasket is disposed adjacent to a corner formed by the circuit board and the housing.

14. The electronic device of claim 1, further comprising:
a battery disposed within the housing; and
a second connection member electrically connecting the circuit board and the battery.

15. The electronic device of claim 1,
wherein the housing includes a first housing, a second housing coupled to the first housing, and a third housing disposed in an internal space formed between the first housing and the second housing,
wherein the third housing includes the first surface and the second surface,
wherein the first surface of the third housing faces the first housing,
wherein the first antenna pattern is disposed on the second surface of the third housing, and
wherein the second antenna pattern is disposed on the first surface of the third housing.

16. An electronic device comprising:
a housing including a first surface facing a first direction and a second surface facing a second direction different from the first direction;
a sound output module disposed within the housing;
a circuit board disposed within the housing;
a first antenna structure disposed within the housing and electrically connected to the circuit board; and
a second antenna structure disposed on the first surface of the housing and configured to be electromagnetically coupled to a first antenna pattern,
wherein the first antenna structure is disposed adjacent to the second surface of the housing,
wherein at least a portion of the first antenna structure faces at least a portion of the second antenna structure with the housing interposed therebetween, and
wherein the second antenna structure is a laser direct structuring (LDS) antenna formed on the first surface of the housing.

17. The electronic device of claim 16, wherein the at least portion of the first antenna structure is formed as a conductive portion.

18. The electronic device of claim 16, wherein the housing includes a first hole and a second hole spaced apart from the first hole, and
wherein the second antenna structure is disposed between the first hole and the second hole.

19. The electronic device of claim 16, wherein the circuit board includes a third surface facing the first antenna structure and the second antenna structure and a fourth surface facing a direction opposite to the third surface, and
wherein the electronic device further comprises a first connection member electrically connecting the third surface of the circuit board to the first antenna structure.

20. An electronic device comprising:
a housing including a first housing including a first surface facing a first direction and a second surface facing a second direction different from the first direction, and a second housing coupled to the first housing;
a sound output module disposed within the housing;
a circuit board disposed within the housing; a first antenna pattern disposed within the housing and electrically connected to the circuit board; and
a second antenna pattern disposed on the first surface of the housing and configured to be electromagnetically coupled to the first antenna pattern,
wherein at a least portion of the first antenna pattern faces at least a portion of the second antenna pattern with the housing interposed therebetween.
